(19) United States
(12) Patent Application Publication
(10) Pub. No.: US 2006/0045270 A1
(43) Pub. Date: Mar. 2, 2006

(54) System and method for information protection by navigation and concealment

(75) Inventor: Roy Cohen, Haifa (IL)

Correspondence Address: DR. MARK FRIEDMAN LTD.;C/o Bill Polkinghorn, 9003 Florin Way, Upper Marlboro, MD, 20772, US

(73) Assignee: PRIVICY INSIDE LTD.

(21) Appl. No.: 11/260,223

(22) Filed: Oct. 28, 2005

Related U.S. Application Data
(63) Continuation of application No. 09/853,717, filed on May 14, 2001.

(51) Int. Cl. H04L 9/00

(52) U.S. Cl. 380/268

(57) ABSTRACT

A system and a method for scrambling data according to a map, which is preferably user-defined, such that the sequential order in which the data must be read is determined by the map. Rather than employing a mathematical formula to scramble the data, the data is separated into a plurality of fragments. A map is then selected for determining the order of the fragments, such that without the map, the fragments cannot be assembled in the correct order. The process of arranging the fragments such that they cannot be correctly read without the map is referred to herein as “scrambling”, as opposed to encryption, as this process does not use a mathematical formula.

### CROSS REFERENCE TO RELATED APPLICATIONS

The present application is a continuation application claiming benefit from U.S. application Ser. No. 09/853,717 filed 14 May 2001, now abandoned.

### FIELD OF THE INVENTION

The present invention relates to a system and a method for information protection by navigation and concealment, and in particular, for such a system and method in which a user selects a map for scrambling and/or encrypting data, the map determining how the scrambled and/or encrypted data is to be read, such that without the complete map, the data is unreadable.

### BACKGROUND OF THE INVENTION

The Internet, and other types of computer networks such as local area networks (LAN) and wide area networks (WAN), have increased the efficiency of data transmission, as well as accessibility to data. Unfortunately, such increased accessibility has also increased the security risks inherent in the transport of data across a network, as well as for the storage of data on a storage device. Unauthorized computer users can also access such data, with the potential for theft and misuse thereof. For example, if an unauthorized user obtains credit card information, such as a credit card number, the stolen information could be used to illegally obtain goods and/or services through the Internet.

In order to combat such potential misuse of data, various encryption methods have been proposed, such as RSA and PGP, for example. All of these encryption methods rely upon a mathematical formula of some type. The data is encrypted with at least one key, according to the formula. The data can then only be read by a user who has the correct key. The drawback of such encryption methods is that they require the use of a mathematical formula, and hence can only be very difficult to break. As computers have become more powerful, certain of these encryption methods which were previously thought to be practically unbreakable, because of the sheer amount of computations which would be required, have in fact been broken. Therefore, data which is protected by such encryption methods is potentially vulnerable to attack, even by unauthorized users who do not possess the key.

A more robust encryption method would not rely upon a mathematical formula, in order to avoid this type of vulnerability to attack. Instead, the encryption method would rely upon a user-defined map. Rather than encrypting the data itself, the method would use the map to deconstruct and store the data, such that the data could not be assembled without the map. Such a method would have the advantage that the data itself could be stored openly, since the data would be unreadable without the map. Unfortunately, such a method is not currently available.

### SUMMARY OF THE INVENTION

The background art does not teach or suggest a system and a method for scrambling data which does not rely upon a mathematical formula, but which instead employs a map for determining a sequential order for reading the data, such that the data is not readable without the map. The background art also does not teach or suggest such a map which is defined by the user.

The present invention overcomes these deficiencies of the background art by providing a system and a method for scrambling and/or encrypting data according to a map, which is preferably user-defined, such that the sequential order in which the data must be read (for scrambled data) or key (for encrypted data) is determined by the map. Rather than employing a mathematical formula to scramble and/or encrypt the data, a plurality of units of data are either scrambled or encrypted according to the map. For example, information at each location of the map is preferably used to determine the order of a plurality of units of data, such that the existing order is rearranged according to information at each location of the map. Alternatively or additionally, the units of data can optionally be encrypted according to the map, for example by adding a numeric value derived from each location of the map to the value of the unit of data. Such encryption is more preferably performed either “bit by bit” for binary data, such that the value for each bit is determined by the location of the map; or bit in bit, in which the order may also optionally be rearranged.

According to preferred embodiments of the present invention, the data is separated into a plurality of fragments. A map is then selected for determining the order of the fragments, such that without the map, the fragments cannot be assembled in the correct order. The process of arranging the fragments such that they cannot be correctly read without the map is also referred to herein as “scrambling”. Optionally and more preferably, the units of data are also scrambled between fragments, such that the order of the units of data is rearranged both within each fragment and also between the fragments.

Optionally and more preferably, the user selects and/or otherwise determines this map for scrambling and/or encrypting the fragments. For example, the user could “draw” such a map by moving the mouse or other pointing device, and/or by operating any other type of input device, thereby forming an effectively randomly created map. Alternatively or additionally, the user is provided with an initial image, which is preferably a fractal. The user then preferably selects a plurality of points from the fractal. Each point can initiate a practically infinite number of navigation paths. Since the points are selected by the user, each individual user would create a different and unique map for determining the order of the fragments.

According to preferred embodiments of the present invention, the fragments of data are scrambled both internally and externally. That is, for internal scrambling, the data within each fragment is scrambled according to an order determined by the map. For example, if the file was originally a binary file, such that the data is binary data, the order of “1” and “0” would be altered by shifting each place of the data according to the map. Most preferably, both whether each place of data is shifted, and the new location for placing shifted data, is determined separately for each data place according to the map. Fragments may even optionally be arranged in a three-dimensional array, and the data in each place could then be shifted between fragments, thereby increasing the complexity of the process for scrambling the data. Another option is to combine a plurality of files into a single file before creating the fragments, thereby also increasing the complexity of the process for scrambling the data.

Each fragment is preferably labeled with the data from the point of the fractal, which is preferably converted to a single number. The map dictates the order in which the fragments are reassembled, such that the map is therefore required in order to reassemble the data in the correct sequence, without which the data is not readable. The next point on the map may optionally be stored with each fragment, or alternatively may be stored separately, in order to increase the difficulty of reassembling the fragments. Thus, the present invention protects the data by only allowing a user who has the correct map to read the data.

For greater security when performing the method of the present invention with a computational device, at least the ports of the computational device are preferably closed to prevent unauthorized access during the process of scrambling. More preferably, only those features of the computational device which are required for the performance of the present invention remain operational, while all other software processes and/or hardware devices are not permitted to function. Thus, a “Trojan horse” or other unauthorized software process is not able to detect the information for unscrambling the data.

According to the present invention, there is provided a method for scrambling data according to a map, the data being composed of a plurality of units of data in a particular sequence, the method comprising: selecting a plurality of points in a particular order to form the map; and scrambling the sequence of the units of data according to the map to form scrambled units of data, such that the map is required to unscramble the scrambled units of data, and such that the scrambled units of data are not readable without the map.

According to another embodiment of the present invention, there is provided a system for scrambling data on a user computer according to a map, comprising: (a) a software module for determining the map and for scrambling the data, the software module being operated by the user computer; (b) a server for receiving the scrambled data from the user computer; and (c) a network connected to the server and the user computer for transmitting the data.

Hereinafter, the term “network” refers to a connection between any two or more computational devices which permits the transmission of data.

Hereinafter, the term “computational device” includes, but is not limited to, any type of computer, as well as any type of device which is capable of performing a computation, including but not limited to, a cellular telephone and a PDA (personal data assistant).

For the present invention, a software application could be written in substantially any suitable programming language, which could easily be selected by one of ordinary skill in the art. The programming language chosen should be compatible with the computational device with which the software application is executed.

In addition, the present invention could be implemented as software, firmware or hardware, or as a combination thereof. For any of these implementations, the functional steps or operations performed by the method could be described as a plurality of instructions performed by a data processor.

Unless otherwise indicated, the term “scrambling” includes both “encrypting” data and rearranging the sequential order of data according to the method of the present invention.

### BRIEF DESCRIPTION OF THE DRAWINGS

The invention is herein described, by way of example only, with reference to the accompanying drawings, wherein:

FIG. 1. is a schematic block diagram of an exemplary system according to the present invention;

FIG. 2 is a flowchart of an illustrative method for scrambling the data according to the present invention;

FIG. 3 is a flowchart of an exemplary method for sequential key exchange according to the present invention; and

FIG. 4 is a second exemplary system according to the present invention for exchanging keys indirectly between two parties.

### DESCRIPTION OF THE PREFERRED EMBODIMENTS

The present invention is of a system and a method for scrambling and/or encrypting data according to a map, which is preferably user-defined, such that the sequential order in which the data must be read (for scrambled data) or key (for encrypted data) is determined by the map. Rather than employing a mathematical formula to scramble and/or encrypt the data, a plurality of units of data are either scrambled or encrypted according to the map. For example, information at each location of the map is preferably used to determine the order of a plurality of units of data, such that the existing order is rearranged according to information at each location of the map. Alternatively or additionally, the units of data can optionally be encrypted according to the map, for example by adding a numeric value derived from each location of the map to the value of the unit of data. Such encryption is more preferably performed either “bit by bit” for binary data, such that the value for each bit is determined by the location of the map; or bit in bit, in which the order may also optionally be rearranged.

According to preferred embodiments of the present invention, the data is separated into a plurality of fragments. A map is then selected for determining the order of the fragments, such that without the map, the fragments cannot be assembled in the correct order. The process of arranging the fragments such that they cannot be correctly read without the map is also referred to herein as “scrambling”. Optionally and more preferably, the units of data are also scrambled between fragments, such that the order of the units of data is rearranged both within each fragment and also between the fragments.

Optionally and more preferably, the user selects and/or otherwise determines this map for scrambling and/or encrypting the fragments. For example, the user could “draw” such a map by moving the mouse or other pointing device, and/or by operating any other type of input device, thereby forming an effectively randomly created map. Alternatively or additionally, the user is provided with an initial image, which is preferably a fractal. The user then preferably selects a plurality of points from the fractal. Each point can initiate a practically infinite number of navigation paths. Since the points are selected by the user, each individual user would create a different and unique map for determining the order of the fragments.

According to preferred embodiments of the present invention, the fragments of data are scrambled and/or encrypted both internally and externally. That is, for internal scrambling, the data within each fragment is scrambled according to an order determined by the map. For example, if the file was originally a binary file, such that the data is binary data, the order of “1” and “0” would be altered by shifting each place of the data according to the map. The value of the coordinates at each point of the map, and/or other information about that point of the map, would optionally and more preferably used to determine the location of each unit of data, such as “1” or “0”. The number(s) derived from each point of the map could optionally be fed into a hash function for determining the location of the unit of data, for example.

Most preferably, both whether each place of data is shifted, and the new location for placing shifted data, is determined separately for each data place according to the map. Fragments may even optionally be arranged in a three-dimensional array, and the data in each place could then be shifted between fragments, thereby increasing the complexity of the process for scrambling the data. Another option is to combine a plurality of files into a single file before creating the fragments, thereby also increasing the complexity of the process for scrambling the data.

Each fragment is preferably labeled with the data from the point of the fractal, which is preferably converted to a single number. The map dictates the order in which the fragments are reassembled, such that the map is therefore required in order to reassemble the data in the correct sequence, without which the data is not readable. The next point on the map may optionally be stored with each fragment, or alternatively may be stored separately, in order to increase the difficulty of reassembling the fragments. Thus, the present invention protects the data by only allowing a user who has the correct map to read the data.

Another aspect of the process is to hide the information which is stored in each fragment. The fragments may be “hidden” by being labeled with names which do not show the relation between fragments, and by also storing fragments from a plurality of users in a common pool on a storage medium. Therefore, an unauthorized user would not be able to reassemble the fragments without the map, simply by “guessing” as to which fragments belong to the correct file. Other aspects of concealing the data may optionally include, but are not limited to, randomly varying the fragment size in order to prevent an unauthorized user from detecting which fragments belong to a particular file; saving at least one fragment at a location other than the server, without which the reassembled fragments are not readable; and varying the expiration date for each fragment, after the user has set a minimum expiration date, up until which the data must remain readable.

According to another preferred embodiment of the present invention, once the units of data in each fragment have been encrypted and/or scrambled, each fragment or other group of units of data is preferably concealed by stegnography in an image. More preferably, each group of units of data is concealed in a separate image. The images may then optionally be “hidden” on a server, for example by storing the images separately, such that even if an unauthorized user is able to access an image, the data contained within that image is still hidden.

Additionally or alternatively, preferably each separate image also contains information for locating another group of data units in another image, such that the groups are concealed in a plurality of sequential images. These sequential images may be considered to form an “infinity movie”, particularly if fractals are used for the images according to the most preferred embodiment, since the series of images hides the groups of units of data in an infinite set of data, and since both the order and the location of the hidden data is important.

Furthermore, if the data is hidden within at least one image, then the data can optionally be efficiently scrambled within the image itself, by performing at least one visual alteration to the image according to a visual effect. For example, one such visual effect is to distort the appearance of an image by unevenly skewing the data along the axes of the image, as for the “magnetic” effect provided through the Adobe Photoshop™ product, which alters the appearance of a portion of the image. Another example of a visual effect is skewing the image. This product may even optionally be used within the present invention in order to create the desired visual effect, as the product also accepts “plug-in” software modules for creating new visual effects and/or manipulating new file formats. Since the image contains hidden data according to the method of the present invention, distorting the image also further conceals the data.

Alternatively or additionally, the visual effect may optionally be performed on the binary file itself, such that each “1” or “0” is altered as a “pixel”, and such that the binary file is viewed as a two-dimensional image for determining the alteration(s) caused by the visual effect. Therefore, optionally and more preferably, a particular “plug-in” software module may be created such that the encrypted and/or scrambled binary file can only be decrypted and/or reassembled with the correct software module for reversing the visual effect. Thus, even if an unauthorized user had a copy of the map for decrypting and/or unscrambling the binary data, without the correct reversal of the visual effect, the data would remain inaccessible.

The third aspect of the process is to optionally and preferably encrypt either the entire file, and/or the fragments of the file, according to a known encryption method such as DES, PGP, RSA and so forth. More preferably, the key is determined from the fractal, such that the data cannot be decrypted without the map which has been created from the fractal by the user. Optionally, a plurality of keys are created, such that each fragment is encrypted according to a different key. Alternatively, a single key could optionally be broken into a plurality of smaller keys. The first key could then optionally and preferably be used to encrypt the second key, and so forth, such that the next key in the sequence is used to encrypt the previous key.

According to other optional but preferred embodiments of the present invention, a particular sequence in time can also be used to further increase the security of data transmission. For example, if two users wish to communicate by exchanging data, such as voice data or messaging data, a map obtained from a fractal could also be used to encrypt the data. In this example, the map would be used to determine the sequence in which the transmitted data should be assembled in order for the data to be readable. In order to further improve the security of this arrangement, the users could also agree to determine the sequence of points within the map according to time, such that after a predetermined period of time has elapsed, the order of the data would be determined according to a new point on the map. Thus, even if an unauthorized user is able to decrypt the data according to a particular point, the continuous switching between points would prevent such a user from understanding any further data.

According to an optional but preferred implementation of transmitting data according to a sequence in time, the previously described plurality of keys could also be sequentially transmitted. In this embodiment, a first key (or a first portion of the key, if a single key has been broken into fragments) would need to be exchanged directly between the parties, even manually if desired. Next, the first key would be used to encrypt the second key, which would then be transmitted from the first party to the second party. The second party could then decrypt the second key by using the first key, and could optionally use the second key to encrypt further communication between the parties. Alternatively or additionally, the second key could then optionally be used to retrieve another fragment of information and to decrypt that fragment.

For greater security when performing the method of the present invention with a computational device, at least the ports of the computational device are preferably closed to prevent unauthorized access during the process of scrambling. More preferably, only those features of the computational device which are required for the performance of the present invention remain operational, while all other software processes and/or hardware devices are not permitted to function. Thus, a “Trojan horse” or other unauthorized software process is not able to detect the information for unscrambling the data.

The principles and operation of the present invention may be better understood with reference to the drawings and the accompanying description.

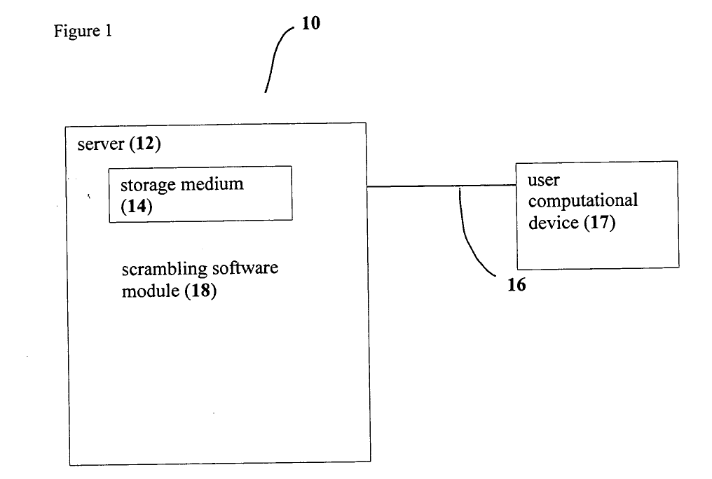

Referring now to the drawings, FIG. 1 is a schematic block diagram of a system according to the present invention for concealing data on a storage device, such that the data can only be retrieved and reassembled in the correct order if the process of assembly is performed according to a sequence determined by a map.

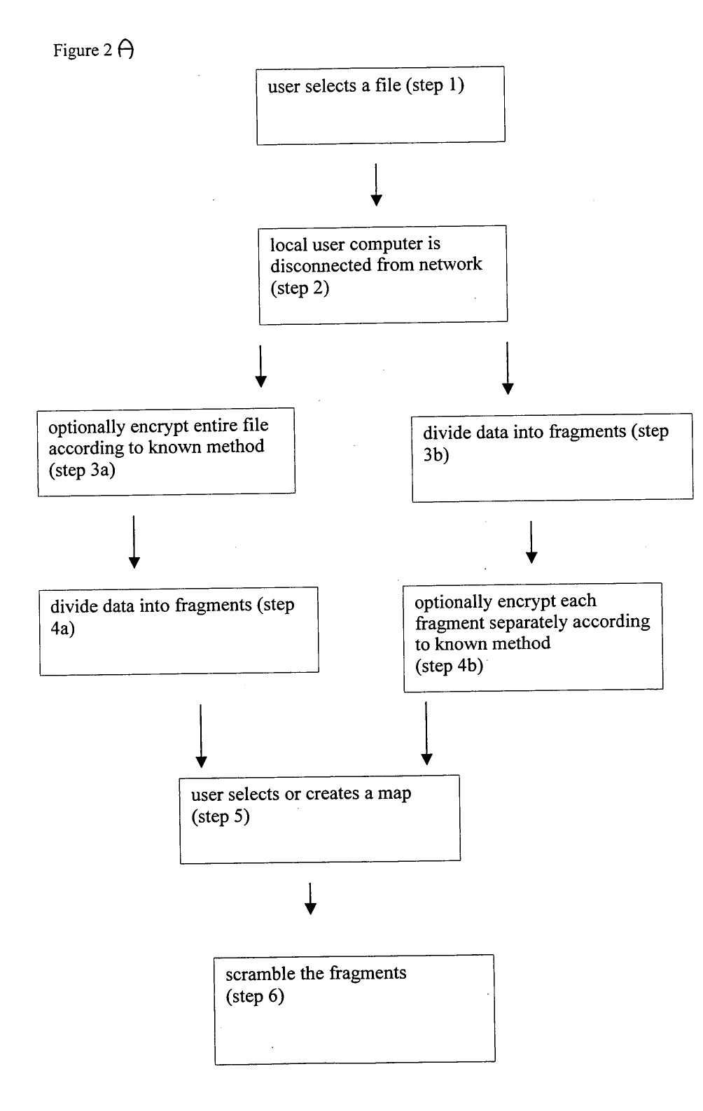

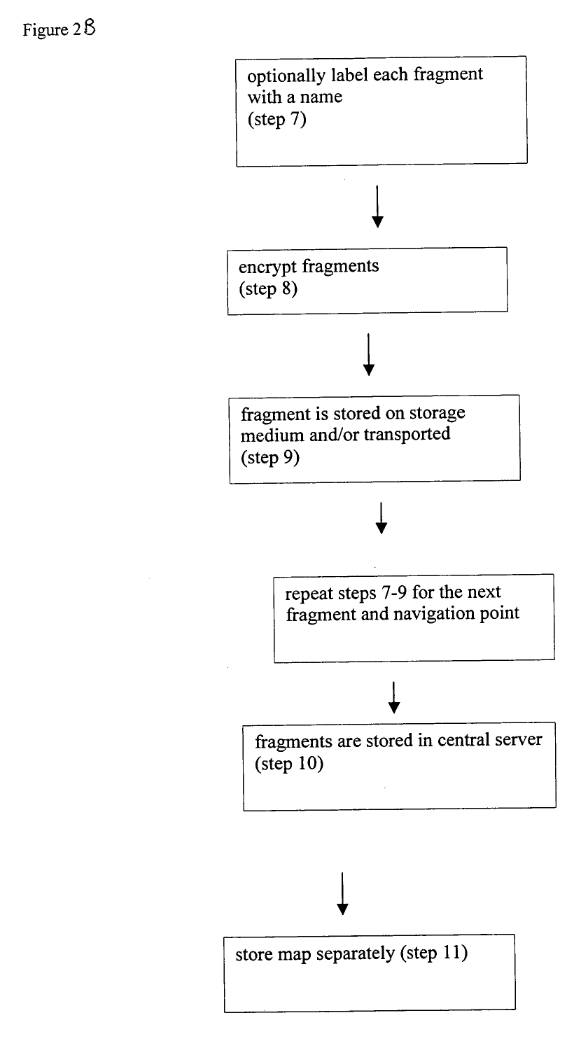

A system 10 features a server 12, with an associated storage medium 14 for storing data. Storage medium 14 could be a magnetic disk or “hard disk”, for example. Server 12 is a computational device which is connected to a network 16, such as the Internet for example. Server 12 receives data for storage on storage medium 14 through network 16. This data is fragmented according to the method of the present invention, explained in greater detail below with regard to FIG. 2.

Preferably, in order to fragment the data, server 12 operates a scrambling software module 18. Alternatively or additionally, scrambling software module 18 may optionally be operated by a computational device other than server 12, such as user computational device 17, such that server 12 only receives the data in scrambled format. In any case, scrambling software module 18 enables the user to create a map, preferably from a source of random numbers such as a fractal for example. The data, which is preferably in the form of a file or a plurality of files assembled into a single file, is then divided into fragments. Once the map has been created, the fragments are scrambled, preferably by altering at least the order of the units of data within each fragment, but more preferably by also altering the order of the units of data between fragments. Additionally or alternatively, the units of data can also be encrypted, for example by determining a value for each unit of data according to a numeric value which is derived from each location on the map. The encrypted value is determined without a mathematical formula, as the encryption is performed according to the map. The manner in which the fragments are unscrambled is determined according to the map. Thus, unless the map is used to assemble the data, the data is unreadable.

For example, the fragments of data from multiple users could optionally be stored in a single collection on storage medium 14. Unless the map is used to both understand which fragments are relevant to a particular file, as well as how to assemble these fragments, then the stored, fragmented data would be useless. As an additional option, the fragments could be encrypted, before or after the data is fragmented and/or scrambled, according to a key. The key is optionally determined from the practically infinite source of random numbers, which is the fractal. Therefore, a user would need to have both the map and to retrieve each portion of data in the correct order in order to locate and assemble the fragments.

According to another preferred embodiment of the present invention, once the units of data in each fragment have been encrypted and/or scrambled, each fragment or other group of units of data is preferably concealed by stegnography in an image. More preferably, each group of units of data is concealed in a separate image. The images may then optionally be “hidden” on storage medium 14 on server 12, for example by storing the images separately in different locations or “file drawers”, such that even if an unauthorized user is able to access an image, the data contained within that image is still hidden, and the ability to locate all of the images is also hidden.

Additionally or alternatively, preferably each separate image also contains information for locating another group of data units in another image, such that the groups are concealed in a plurality of sequential images. These sequential images may be considered to form an “infinity movie”, particularly if fractals are used for the images according to the most preferred embodiment, since the series of images hides the groups of units of data in an infinite set of data, and since both the order and the location of the hidden data is important. Such an infinity movie is useful for both storing and transmitting data.

In addition, optionally and preferably server 12 has a time limit for the period of time for which the map is valid. For example, the user could request that the stored data can only be retrieved for a certain number of days, after which the stored data is destroyed. Alternatively, server 12 could also optionally permit the data to be retrieved once, after which the data would also be destroyed.

For additional security, the user could also optionally remove one fragment of the data, before it is stored on storage medium 14. The user would then need to supply this missing fragment of data during the process of assembly for the reassembled data to be readable. Thus, an unauthorized user would not only need to obtain the missing fragment of data, such an unauthorized user would also need to know the point at which the missing fragment of data is to be inserted during the process of reassembly, according to the map.

According to yet another implementation of the present invention through server 12 of system 10, two users could optionally and preferably communicate with a shared map through server 12. For example, during an IP telephone call, which is a telephone call performed through a network such as the Internet, two users could agree that data would be fragmented according to the shared map by scrambling software module 18 of server 12. As an additional security measure, the users could also agree to shift to different points within the map according to a particular time schedule, such that an unauthorized user who is attempting to reassemble the data would only know the previous point on the map, but not the new correct point on the map.

If scrambling software module 18 is operated by user computational device 17, then optionally and more preferably, scrambling software module 18 also operates continuously at the background of all software processes, thereby enabling all of the data which is to be stored on a local storage medium of user computational device 17 to optionally be scrambled, most preferably before being stored on the local storage medium (rather than being written first and then scrambled). Furthermore, any data which is stored on the local storage medium, whether permanent or temporary, could optionally be scrambled, as well as any unwritten space of the storage medium. Such a feature gives added security by preventing an unauthorized user from determining which areas of the computer contain files, and also by preventing computer “viruses” and other unauthorized software instructions from becoming attached to these files.

FIG. 2 is a flowchart of an exemplary method according to the present invention for scrambling and/or encrypting data. Any type of data may potentially be concealed according to this method, including but not limited to, audio, voice, text, video, graphic image and other types of data. The method of the present invention preferably operates with the system of FIG. 1.

In step 1, the user selects a file, whether stored locally or at a remote site, according to any storage mechanism. In step 2, the local computational device being operated by the user is preferably disconnected from any type of network connection, in order to protect the data during the process of scrambling and/or encryption. For greater security, more preferably, only those features of the local computational device which are required for the performance of the present invention remain operational, while all other software processes and/or hardware devices are not permitted to function. Thus, a “Trojan horse” or other unauthorized software process is not able to detect the information for unscrambling the data.

In step 3a, the entire file is optionally and preferably encrypted according to a mathematical formula, for example according to a method which is known in the art such as DES, PGP, and so forth. In step 4a, the encrypted file is preferably divided into a plurality of fragments. Preferably, steps 3a and 4a are performed according to the preference of the user, such that the user selects the encryption method and the method by which the file is divided.

As an alternative method, in step 3b, the file is divided into a plurality of fragments. In step 4b, optionally and preferably each fragment is encrypted according to a mathematical formula, for example according to a method which is known in the art such as DES, PGP, RSA and so forth. Alternatively, the data is not encrypted at this stage, but instead is encrypted at a later stage, as described in greater detail below.

In step 5, the user selects or creates a map according to which the data is scrambled. For selecting the map, preferably the user selects points from a fractal, which more preferably also includes selecting a resolution, the coordinates of the first navigation point for the map, and the color bar code for the fractal. Alternatively, the colors may optionally be removed from the fractal. Other options include, but are not limited to, selecting a navigation time point, which is the magnification of the movement to the next point. In other words, the amount of time which is required to move to the next navigation point is selected. This amount of time, as well as the rate at which movement has occurred, is most preferably used for the previously described preferred embodiment in which two or more users agree on a shared map, which is then constructed on the fly as the users interact by exchanging data for example. Without the knowledge of the amount of time which must elapse, as well as the rate at which movement occurs across the fractal, an unauthorized user cannot correctly select the next navigation point on the shared map.

If a plurality of fractals is used for the shared map, then navigation can also optionally occur between points in different fractals, the order of which also forms part of the shared map. For each selected pixel, the resolution, the color bar code, the coordinates, the location of the pixel relative to the fractal itself, and the time point are all preferably collected.

For creating the map, preferably the user manipulates a mouse or other pointing device, and/or operates any other type of input device, which is connected to the user computational device in order to “draw” the map.

In step 6, the data units within the fragments are scrambled and/or encrypted according to the map. For example, the units of data are scrambled by altering the order of the data location for at least certain units of data. The units of data are encrypted by altering a value for at least certain units of data according to numeric values obtained from the map. One example of a “unit” of data for binary data is “1” or “0”. For scrambling, the order of the units is therefore rearranged at least within the fragment, and more preferably between fragments, in order to scramble the data. The order for scrambling is determined by the map which was created as previously described, such that without the map, the data cannot be reassembled correctly.

In step 7, each fragment is optionally labeled with a file name. The file name can optionally be used to directly name the fragment for storage and/or transport, or alternatively, can be stored separately with the map, and a different name used for the fragment. This file name is preferably created from information which is hidden in a second map, which may also optionally be a fractal and/or created by the user as previously described. For this option, preferably the file name is taken from a string of numbers which describes each selected point of the fractal and/or of the map which is created by the user. For example, for the fractal, such a selected point or pixel may be described according to one or more of the resolution, the color bar code, the coordinates, the location of the pixel relative to the fractal itself, and the time point, as previously described. According to a preferred embodiment of the present invention, the label for each successive fragment in a particular sequence is stored in the map which is used to determine the label for that fragment. Alternatively or additionally, preferably the data for the entire fragment is “hidden” in the map or a portion thereof, particularly if the map is a fractal, in a process known in the art as stegnography. Such a process may optionally be performed with software such as the Invisible Secrets™ software of Secretec Inc.

More preferably, the size of the fragments is varied, such that a plurality of fragments of different sizes is created, in order to further increase the difficulty of assembling the fragments without the map. Also more preferably, the user determines the level of security and/or other rules for creating the fragments and scrambling the data.

In step 8, if the fragments were not previously encrypted according to a known encryption method, optionally and preferably these fragments are encrypted in this step. Alternatively, if the units of data within fragments were scrambled at a previous stage, then optionally and more preferably, these units of data are now encrypted according to the method of the present invention. Also alternatively, if the units of data within fragments were encrypted at a previous stage according to the method of the present invention, then optionally and more preferably, these units of data are now scrambled according to the method of the present invention.

In step 9, the fragment is stored on the storage medium and/or transported to the next destination. Steps 7-9 are then repeated for the next fragment and the next navigation point on the map.

In step 10, if the fragments are transmitted to a central server, then preferably the server stores these fragments without any indication as to the correct order. More preferably, the server stores the fragments from a plurality of users without any type of structure or file hierarchy, such that each fragment is located on the storage device of the server only according to the name of that fragment, as an additional security measure. The server may also optionally at this stage hide the fragments in a fractal or other map, according to stegnography. Optionally, if the fragments are stored at a central server, fragments from a plurality of users are stored in a mixed directory, in order to further conceal the information. If the data is stored in a binary format and/or is encrypted, which is preferred, then even if one of the fragments is located correctly by an unauthorized user, the data is meaningless.

The map is preferably stored separately in step 11. Alternatively, the user may also choose to store the map at the server, protected by a password or other type of protection.

In order to be able to reassemble the fragments, the map is used to determine the sequence. In addition, if the entire file was encrypted, then the previously collected information from the pixels is optionally and preferably used as the key for the encryption, optionally by combining the collected information linearly from the navigation points. If the file was first fragmented before encryption, then the collected pixel information from each navigation point optionally forms the key for encrypting that fragment. Alternatively, only a portion of the collected information, such as the color bar code, may be used as the key. Therefore, this collected information is required for decrypting the file.

As another optional embodiment, at least one fragment is stored separately by the user, rather than on the server. This fragment must also be added in the correct order. Most preferably, the separately stored fragment is either the first fragment or the last fragment. Also most preferably, the first fragment and the last fragment are separately stored.

In addition, the fragments which are stored on the server preferably cannot be destroyed by the user. Rather, the user selects a time of destruction, after which the server automatically destroys the file. More preferably, the user selects the minimum time of destruction, after which the server assigns separate destruction times randomly for each fragment after this minimum time has elapsed, in order to prevent unauthorized users from determining which fragments belong to a single file according to the time of destruction.

As yet another optional embodiment, at any point in the above method, the “shape” of the fragments may be altered (or new fragments created with the new “shape”). By “shape”, it is meant that the boundaries for dividing a data file, and/or redividing a plurality of fragments, is determined according to an irregular edge. For example, if a flat data file is viewed as a grid on an x-axis and a y-axis, then the boundary for dividing the file could optionally be determined by shifting both the values for the “x” positions and the “y” positions simultaneously, thereby producing an irregular edge. If the file is divided into fragments, and the fragments are arranged as a (logical rather than physical) three-dimensional array with x-, y- and z-axes, then the boundary for dividing the file could optionally be determined by shifting values for any two or more of the “x” positions, “y” positions and “z” positions simultaneously. Thus, the file would be divided into pieces of different, irregular sizes, for greater security.

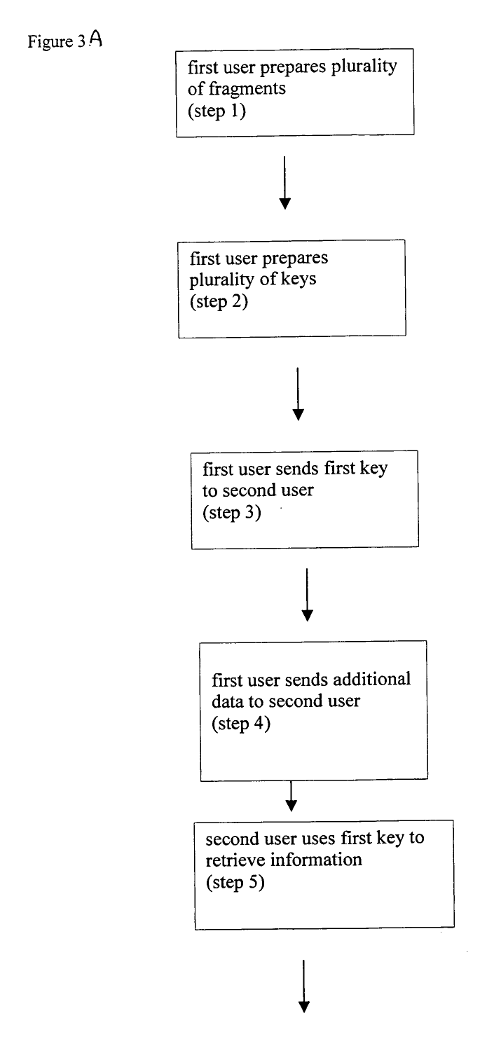

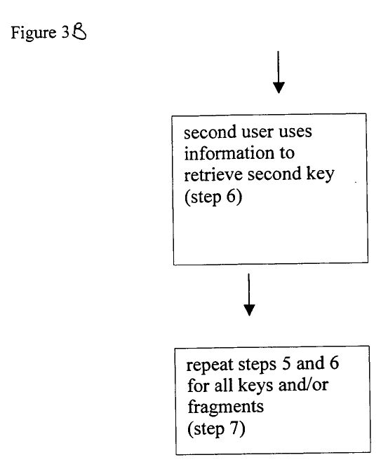

FIG. 3 is a flowchart of another exemplary method according to the present invention, which uses the server as a central repository for information which is then sequentially retrieved and decrypted by two parties. These two parties may, for example, be two separate user computational devices which are being operated by two separate users.

In step 1, the first user prepares a plurality of fragments, which as previously described are at least scrambled and then loaded to the server. In addition, the first user prepares a plurality of keys and/or fragments of a single key in step 2, also as previously described, such that each successive key more preferably contains both the information which is required to decrypt the next key, and also information about the location of the next fragment on the server.

In step 3, the first user sends the first key to the second user, optionally in advance of communication between the two users through their respective user computational devices. Alternatively, if the key is not being used for communication, then the first user sends the first key (or first key fragment) to the second user when the second user is to be permitted to retrieve the secured data on the server. It should be noted that designations such as “first” and “second” do not necessarily refer to the order in which the keys and/or the data which they secure must be assembled, but only to the order of retrieval.

In step 4, optionally and more preferably, the first user also sends certain information which is required to use the first key. For example, if each key is a fractal image, which in fact contains an infinite number of different images or “fractal worlds”, both the coordinates of the hidden data and the particular “fractal world” must be known to receive the key data. The first user could optionally send only one of the coordinates or the “fractal world” to the second user with the key, and could then send the missing information by a separate communication channel (such as through voice communication over a telephone, for example).

According to the preferred embodiment of this method, in step 5, the second user uses the information from the key to both locate data on the server and to unscramble it. Most preferably, once the second user has successfully retrieved the stored data from the server, that stored data is automatically destroyed, so that only the second user is able to retrieve that data. Also most preferably, the stored data includes the second key (or key fragment), although alternatively, the first user sends the second key to the second user.

In step 6, the second user uses the first key to decrypt the second key. The second key is then preferably used to retrieve data as described with regard to the first key. Alternatively, the second key may then optionally be used alone in order to encrypt the communication between the two user computational devices, such that rapidly switching between successive keys would enable the two users to communicate even in the case of a “sniffer” or a “man-in-the-middle” attack. By the time that an unauthorized party is able to determine the identity of the new key, the key would have been switched again.

In step 7, this process is preferably repeated, until the second user has received and unscrambled the data and/or the process of communication is finished.

According to an alternative embodiment of the present invention, rather than sending a key, only the necessary information for locating the key within an image is sent, such as the coordinates of the point within a fractal image and a definition of the fractal “world” or navigation point for locating these coordinates. If this necessary information is split into two groups, such that one group contains the coordinates while another contains the navigation point, for example, then the information could even optionally be sent by two separate insecure communication channels.

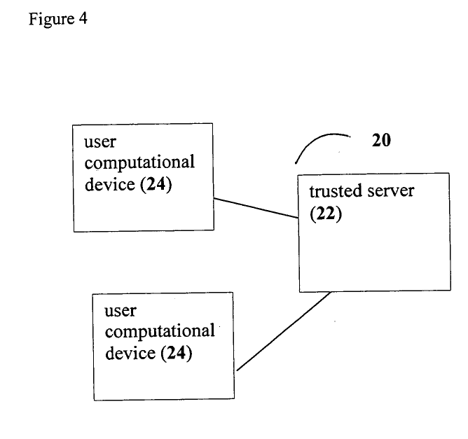

FIG. 4 shows yet another preferred embodiment of the present invention, which is an exemplary system for exchanging keys without direct communication between two parties. As shown, a system 20 features a trusted server 22, which is in communication with a plurality of end user computational devices 24. A first end user computational device 24 is to be used to communicate with a second end user computational device 24. First end user computational device 24 has a first key which is stored on trusted server 22, while second end user computational device 24 has a second key which is also stored on trusted server 22. Both the first and second keys may optionally be determined and/or assigned by trusted server 22.

In order to initiate communication, first end user computational device 24 sends a request to trusted server 22, to encrypt the first key by using the second key, and then to send the encrypted first key to second end user computational device 24. Second end user computational device 24 can now decrypt the first key, and can use the first key to encrypt information for transmitting to first end user computational device 24. However, preferably these keys are actually used to scramble data as previously described, and/or to initiate a sequential exchange of keys also as previously described. Therefore, both first and second end user computational devices 24 are able to exchange scrambled data without first directly exchanging their private keys.

It should be noted that the present invention is also operative with a computational device, such as a cellular telephone, which lacks a mouse or other pointing device for “drawing” a map. For these devices, a map may optionally be selected through the keypad or other input device, and then more preferably is itself altered by being divided into different fragments, which are then reassembled in order to form the final map.

The present invention is of a system and method which are useful for encrypting and/or scrambling data according to a map, thereby providing strong protection for the data, since the map cannot be derived from outside information and/or a brute force attack. The protected data is optionally stored on a storage device, and/or transmitted to another user and/or a central server. As another option, the protected data may be used as a key to be exchanged between two or more parties, for example for communication between the parties. Furthermore, the present invention is useful for producing a key which can replace the PKI (public key infrastructure) system, since as previously described, the method of the present invention enables a key to be created which is hidden in an image, such as a fractal, and which therefore is not susceptible to a brute force attack. However, the present invention is also optionally used in conjunction with any other type of encryption method, even those methods which use a mathematical formula for encryption, and can also optionally be used to secure any type of non-secure communication channel. The present invention is also particularly useful as it requires a relatively small amount of computational power to be operative, since it does not require multiple reading and writing steps for encrypting data. Instead, the data are optionally encrypted after reading (for example, to a volatile memory such as RAM (random access memory)) but before writing to a permanent storage.

While the invention has been described with respect to a limited number of embodiments, it will be appreciated that many variations, modifications and other applications of the invention may be made.

What is claimed is:

1. A method for scrambling computerized data in a computer according to a map, the data being composed of a plurality of units of data in a particular sequence, the method comprising:
(a) randomly selecting a plurality of points in a particular order to form the map; and
(b) scrambling the units of data according to the map to form scrambled units of data in a random sequence, such that said scrambled units of data are not readable without the map; wherein the map is required to unscramble said scrambled units of data by shifting said scrambled units of data to the particular sequence, thereby restoring the particular sequence.

2. The method of claim 1, further comprising the step of:
(c) unscrambling said scrambled units of data by shifting said scrambled units of data to the particular sequence.

3. The method of claim 1, further comprising the step of:
(c) manually creating the map by a user using a device operatively attached to the computer.

4. The method of claim 1, further comprising the step of:
(c) displaying a fractal to a user on a display attached to the computer; and; wherein said plurality of points is selected from said fractal.

5. The method of claim 1, further comprising the step of, wherein the computer has at least one network connection, further comprising the step of prior to said selecting:
(d) pausing said at least one network connection.

6. A method for protection of computerized data, wherein the data is in a particular sequence, the method performed by a first user of a first computational device and a second user of a second computational device, the method comprising the steps of:
(a) randomly selecting a plurality of random points thereby generating a random map, wherein said selecting is performed on said first computational device by the first user;
(b) shifting the computerized data, wherein said shifting being performed by said first computational device is based on said map, wherein said shifting disorders the computerized data into a random sequence of disordered data; and
(c) creating a first key based on said map, wherein said first key is operative for unscrambling said disordered data by the second computational device into the particular sequence.

7. The method, according to claim 6, further comprising the step prior to said fragmenting:
(d) unscrambling the disordered data by a second user of a second computerized device, wherein said unscrambling is performed according to said first key by shifting the disordered data into the particular sequence, thereby storing the computerized data.

8. The method, according to claim 7, wherein said disordered data includes a second key is operative to unscramble further disordered data originating from the first user.

9. The method according to claim 6, wherein the first computational device has at least one application running, further comprising the step of prior to said selecting:
(d) pausing said at least one application.

10. The method, according to claim 6, further comprising the step of:
(d) fragmenting the computerized data into fragments based on said map; wherein said generating a random map includes dividing said random map into a plurality of map portions and distributing said map portions among said fragments.

11. The method, according to claim 6, wherein said generating a random map includes dividing said random map into a plurality of map portions wherein said first key includes varying the order of said map portions based on time.

12. The method, according to claim 6, wherein at least a portion of said disordered data is concealed in an image.

13. The method, according to claim 6, wherein said first key includes information about a location for storing at least a portion of the disordered data.

14. The method, according to claim 6, wherein said first key includes at least a portion of said random map.

15. The method, according to claim 6, wherein a plurality of sequential keys are used in sequential order, wherein at least one said sequential key is disordered based upon at least one previous said sequential key.

16. The method, according to claim 6, wherein a plurality of sequential keys are used in sequential order alternating between said first user and said second user, wherein said at least one sequential key is disordered based further on at least one additional random map.

17. The method, according to claim 6, wherein a plurality of sequential keys are used in sequential order wherein at least one of said sequential keys includes location information of a next said portion of the disordered data.

18. A system for protection of computerized data, the data being composed of a plurality of units of data in a particular sequence, the system comprising:
a first user and and a second user each using at least one computational device wherein said first user selects a plurality of random points thereby generating a random map;
wherein said at least one computational device randomly fragments the computerized data into a plurality of fragments based on said map, each said fragment including a portion of the computerized data;
wherein said at least one computational device shifts said fragments based on said map and thereby disorders the computerized data into disordered computerized data,
wherein said at least one computational device creates a first key based on said map, wherein said first key is operative for unscrambling said disordered computerized data by the second user by shifting said disordered computerized data into the particular sequence, thereby restoring the computerized data.

19. A program storage device readable by a machine, tangibly embodying a program of instructions executable by the machine to perform a method for scrambling computerized data in a computer according to a map, the data being composed of a plurality of units of data in a particular sequence, the method comprising:
(a) randomly selecting a plurality of points in a particular order to form the map; and
(b) scrambling the units of data according to the map to form scrambled units of data in a random sequence, such that said scrambled units of data are not readable without the map; wherein the map is required to unscramble said scrambled units of data by shifting said scrambled units of data to the particular sequence, thereby restoring the particular sequence.

20. A method of unscrambling scrambled computerized data in a computer, wherein computerized data in a particular sequence is scrambled according to a map into the scrambled computerized data, wherein the map is generated by human random action using a device attached to the computer, the method comprising the step of:
(a) shifting said scrambled computerized data to the particular sequence, thereby restoring the particular sequence.
